(19) United States
(12) Patent Application Publication
(10) Pub. No.: US 2024/0351511 A1
(43) Pub. Date: Oct. 24, 2024

(54) Reference Axis Adjustment Controller and Reference Axis Adjustment Method Thereof

(71) Applicant: Compertum Microsystems Inc., Hsinchu City (TW)

(72) Inventor: Francis Piu MAN, Hsinchu City (TW)

(73) Assignee: Compertum Microsystems Inc., Hsinchu City (TW)

(21) Appl. No.: 18/138,140

(22) Filed: Apr. 24, 2023

(51) Int. Cl. B60Q 1/00; B60Q 1/06; G01S 7/481; G01S 7/497

(52) U.S. Cl. CPC B60Q 1/0023; B60Q 1/06; G01S 7/4817; G01S 7/4972; G01S 17/89

(57) ABSTRACT

A reference axis adjustment method and a reference axis adjustment controller thereof are disclosed. The reference axis adjustment method for the reference axis adjustment controller includes obtaining an inclination angle of a slope with respect to a relative horizontal plane, and instructing to adjust a reference axis of an apparatus according to the inclination angle of the slope before the apparatus enters the slope.

### BACKGROUND OF THE INVENTION

### 1. Field of the Invention

The present invention relates generally to automotive light transmitter apparatus in particular to automotive headlight and Light Detection and Ranging (LiDAR) application.

### 2. Description of the Prior Art

An automotive light transmitter apparatus, such as an automotive headlight or a LiDAR apparatus, emits visible or invisible light substantially parallel to a road surface to maximize its illumination on the road ahead. However, before an automobile enters a downward slope, the automotive light transmitter apparatus will shine more on the sky than on the downhill road surface. When an automobile approaches an upward slope, the automotive light transmitter apparatus will have a shorter range of visibility on the road surface. With the advent of Autonomous Driving Assist System (ADAS), an automobile calls for a sensor capable of measuring the inclination angle of the incoming slope and is required to adjust the tilt angle of the automotive light transmitter apparatus accordingly for optimal illumination on the road surface.

### SUMMARY OF THE INVENTION

It is therefore a primary objective of the present invention to disclose a reference axis adjustment controller and reference axis adjustment method thereof to realize an automotive light transmitter apparatus with adaptive tilt angle.

An embodiment of the present invention discloses a reference axis adjustment method, for a reference axis adjustment controller, comprising obtaining an inclination angle of a slope with respect to a horizontal plane; and instructing to adjust a reference axis of an apparatus according to the inclination angle of the slope before the apparatus enters the slope.

An embodiment of the present invention discloses a reference axis adjustment controller, comprising a storage circuit, configured to store instructions of obtaining an inclination angle of a slope with respect to a horizontal plane and instructing to adjust a reference axis of an apparatus according to the inclination angle of the slope before the apparatus enters the slope; and a processing circuit, coupled to the storage device, configured to execute the instructions stored in the storage circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a reference axis adjustment controller according to an embodiment of the present invention.

FIG. 2 is a schematic diagram of a smart device according to an embodiment of the present invention.

FIG. 3 is a schematic diagram of how the angle polarity of a slope is defined according to an embodiment of the present invention.

FIG. 4 is a schematic diagram of a top view of point cloud data measured using LiDAR technology according to an embodiment of the present invention.

FIG. 5 is a schematic diagram of a side view of the point cloud data shown in FIG. 4.

FIG. 6 is a schematic diagram of the relationship between an actual inclination angle and its corresponding inclination angle measured according to point cloud data from a LiDAR apparatus according to an embodiment of the present invention.

FIG. 7 and FIG. 8 are schematic diagrams of reference axis adjustment methods according to embodiments of the present invention.

FIG. 9 is a schematic diagram of a reference axis adjustment controller and an adjuster according to an embodiment of the present invention.

FIG. 10 and FIG. 11 are schematic diagrams of automotive lamp apparatuses according to embodiments of the present invention.

FIG. 12 is a schematic diagram of a LiDAR apparatus according to an embodiment of the present invention.

### DETAILED DESCRIPTION

The technical features described in the following embodiments may be mixed or combined in various ways as long as there is no conflict between them.

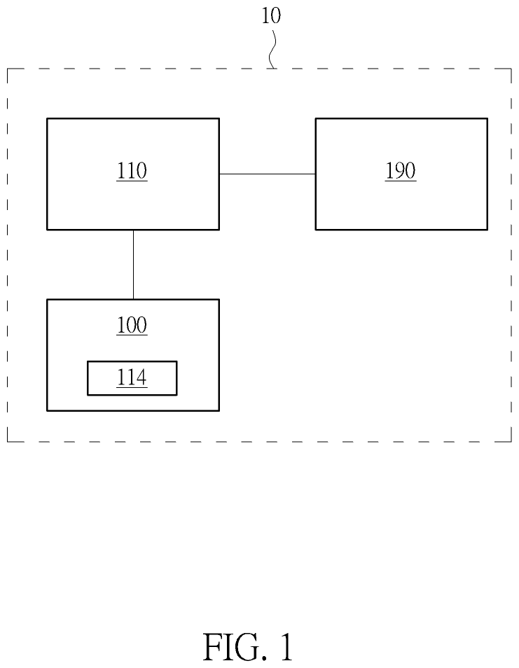

FIG. 1 is a schematic diagram of a reference axis adjustment controller 10 according to an embodiment of the present invention. The reference axis adjustment controller 10 may include a processing circuit 100, a storage circuit 110, and an adjuster 190. The storage circuit 110 is configured to store a program code 114. The processing unit 100 may read and execute the program code 114 through the storage circuit 110.

The adjuster 190, which may be a tilt angle adjuster, is configured to automatically adjust a reference axis or a tilt angle of an apparatus (e.g., a headlamp or a Light Detection and Ranging (LiDAR) apparatus) according to the pitch angle of a vehicle or the inclination angle of a road surface with respect to a (relative) horizontal plane. The (relative) horizontal plane may be horizontal relative to the vehicle but it may not be an absolute horizontal plane, which is usually measured by an accelerator and is perpendicular to the direction of the gravitational force. This ensures that the apparatus is properly aimed or have an optimal view. For example, a headlamp may provide more efficient illumination of the road ahead, and a LiDAR apparatus may measure ranges (variable distances) to object(s) or surface(s) more effectively.

The processing circuit 100 is configured to determine/measure/obtain the pitch angle of a vehicle or the inclination angle of a road surface with respect to the (relative) horizontal plane and instruct the adjuster 190 to adjust the reference axis of the apparatus (according to the program code 114). The reference axis adjustment controller 10 may not include a physical inclination angle sensor but instead leverage/analyze data from other component(s)/sensor(s) to function as a virtual inclination angle sensor. In an embodiment, the reference axis adjustment controller 10 may make the angle measurement(s) by using an automotive height sensor, an automotive inclination detection device, a gravity sensor, a three dimensional (3D) gyro sensor, an inclinometer, or an acceleration sensor when a vehicle is on a slope. In another embodiment, a vehicle may call for a remote sensor that can measure the inclination angle of the incoming slope before the vehicle enters the incoming slope, and the reference axis adjustment controller 10 may make the angle measurement(s) by leveraging LiDAR technology (e.g., a LiDAR-based inclination angle sensor which makes use of point cloud data), radar technology, photography technology (e.g., camera(s)), or other remote sensing technology.

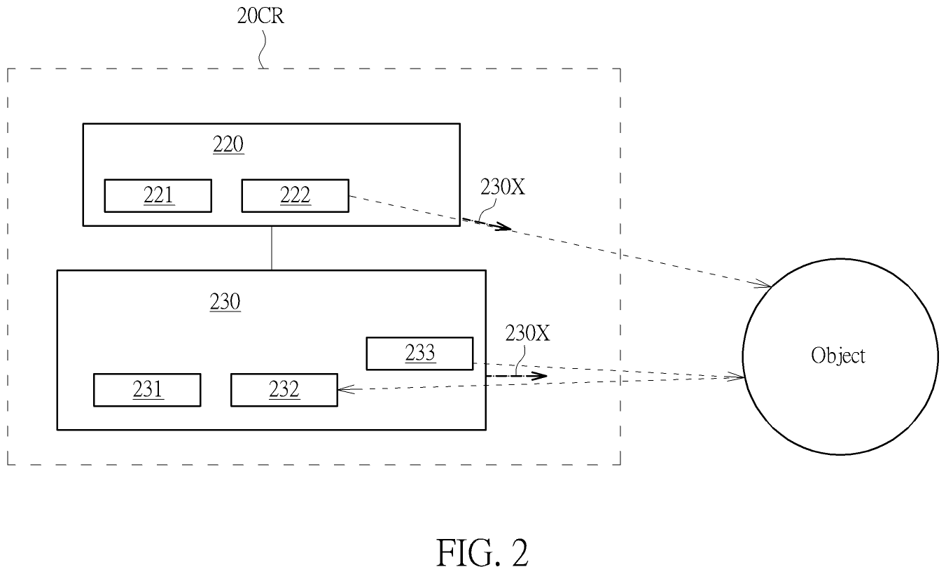

FIG. 2 is a schematic diagram of a smart device 20CR according to an embodiment of the present invention. The smart device 20CR may be disposed in a vehicle. The smart device 20CR may include at least one apparatus (e.g., an automotive lamp apparatus 220 or a LiDAR apparatus 230).

The automotive lamp apparatus 220 may be a headlamp or a tail light. The automotive lamp apparatus 220 may include a reference axis adjustment controller 221 and a light transmitter 222. The reference axis adjustment controller 221 is configured to adjust a reference axis 220X of the automotive lamp apparatus 220 according to the pitch angle of a vehicle or the inclination angle of a road surface with respect to the (relative) horizontal plane to alter the tilt angle of the automotive lamp apparatus 220 and thus change the irradiating direction. The reference axis 220X is an imaginary line that defines the path along which light propagates through the automotive lamp apparatus 220, and may be an optical axis, a part of a central line of a light beam, or an axis along which there is some degree of rotational symmetry in the light transmitter 222.

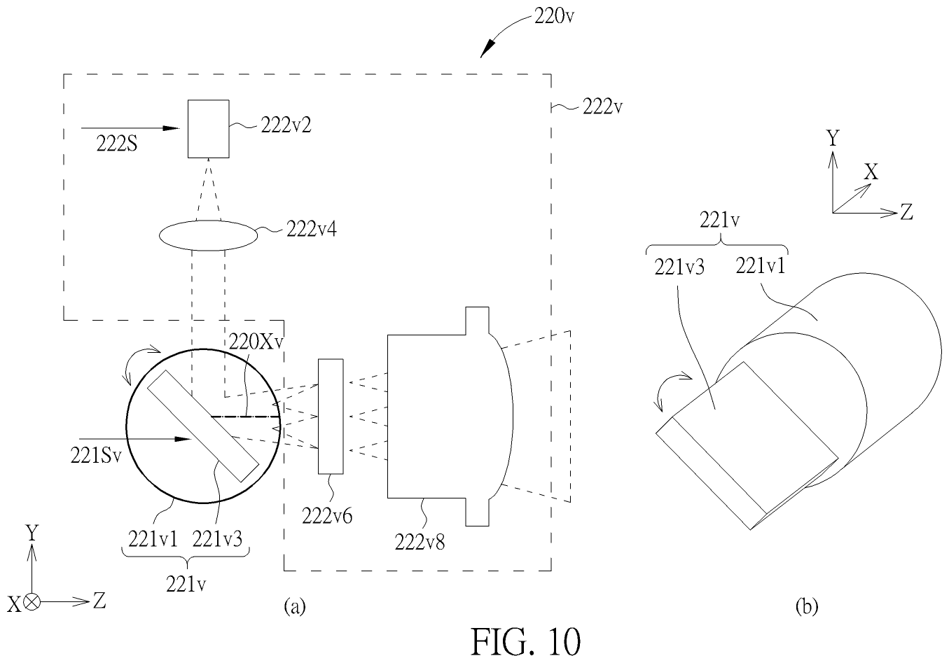

In an embodiment, the light transmitter 222 is configured to emit visible light to flash/illuminate a two dimensional (2D) field of view. Correspondingly, the reference axis adjustment controller 221 may include a (tilt angle) adjuster (e.g., a motor), which is controlled by a tilt angle control signal, to adjust the tilt angle of the automotive lamp apparatus 220. The adjuster may be designed similarly to the adjuster 190. For example, FIG. 10 is a schematic diagram of an automotive lamp apparatus 220v according to an embodiment of the present invention. In FIG. 10, (a) illustrates a side view of the automotive lamp apparatus 220v, (b) illustrates a perspective view of a reference axis adjustment controller 221v of the automotive lamp apparatus 220v. The automotive lamp apparatus 220 may be implemented in the form of the automotive lamp apparatus 220v, which may include the reference axis adjustment controller 221v and a light transmitter 222v. The light transmitter 222v may include a laser 222v2, which is configured to receive laser driving signal(s) 222S, a collimator 222v4, a phosphor plate 222v6, and a projection lens 222v8. The reference axis adjustment controller 221v, which is configured to adjust a reference axis 220Xv of the automotive lamp apparatus 220v, may include a motor 221v1, which is configured to receive motor driving signal(s) 221Sv, and a reflector 221v3 (e.g., a mirror).

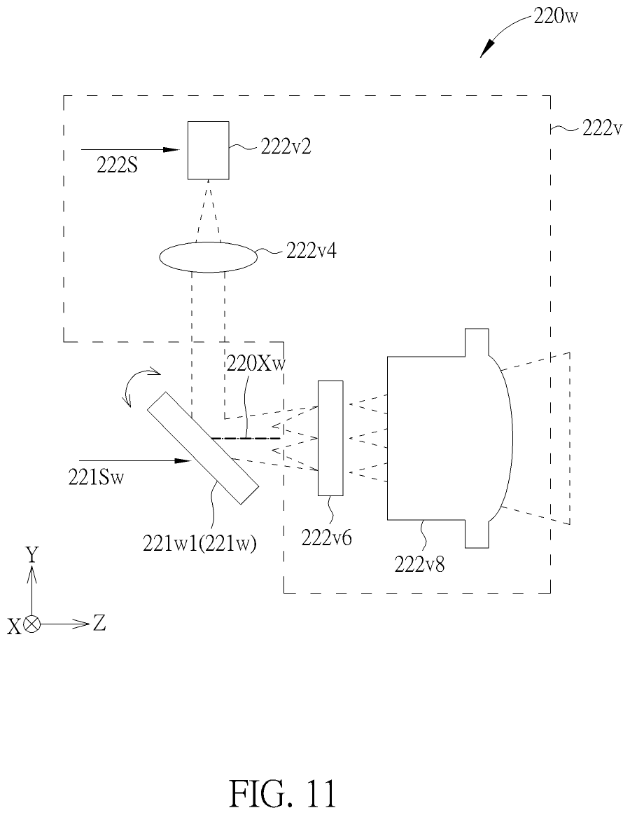

In another embodiment, the light transmitter 222 is configured to emit visible light to scan/illuminate a 2D field of view. Correspondingly, the reference axis adjustment controller 221 may include a (tilt angle) adjuster (e.g., a MEMS mirror or array of MEMS mirrors) to alter the tilt angle of the automotive lamp apparatus 220 by changing offset(s) (e.g., an offset voltage or offset current) of the vertical scanning of the MEMS mirror(s). The adjuster may be designed similarly to the adjuster 190. For example, FIG. 11 is a schematic diagram of a side view of an automotive lamp apparatus 220w according to an embodiment of the present invention. The automotive lamp apparatus 220 may be implemented in the form of the automotive lamp apparatus 220w, which may include a reference axis adjustment controller 221w and the light transmitter 222v. The reference axis adjustment controller 221w, which is configured to adjust a reference axis 220Xw of the automotive lamp apparatus 220w, may include a MEMS mirror 221v1, which is configured to receive MEMS driving signal(s) 221Sw.

In an embodiment, the reference axis adjustment controller 221 may obtain the pitch angle of a vehicle or the inclination angle of a road surface by leveraging LiDAR technology (e.g., using point cloud data output from the LiDAR apparatus 230) to alter the tilt angle of the automotive lamp apparatus 220.

The LiDAR apparatus 230 may include a reference axis adjustment controller 231, a light transmitter 232, and a light receiver 233. The light transmitter 232 is configured to emit non-visible light to scan/illuminate a 2D field of view. The LiDAR apparatus 230 is configured to measure distances to object(s) by emitting at least a non-visible laser pulse or flash to object(s) in the surrounding environment (with the used of the light transmitter 232), and receiving at least a returned pulse signal reflected from the object(s) by (with the used of the light receiver 233). The distances to object(s) are computed using a time of flight method that measures the time delay between the pulse light and the reflected pulse light. The LiDAR apparatus 230 may provide a 3D representation of object(s) known as point cloud data, which is created by collecting distance-to-object-data in a 2D space.

The reference axis adjustment controller 231 is configured to adjust a reference axis 230X of both the light transmitter 232 and the light receiver 233 of the LiDAR apparatus 230 according to the pitch angle of a vehicle or the inclination angle of a road surface with respect to the (relative) horizontal plane to alter the tilt angle of the LiDAR apparatus 230 and thus change the measuring direction. In other words, the light transmitter 232 and the light receiver 233 (or the LiDAR apparatus 230) are tilted or adjusted together. The reference axis 230X is an imaginary line that defines the path along which light propagates through the LiDAR apparatus 230.

In an embodiment, the LiDAR apparatus 230 may further include a beam steering unit optically coupled between the light transmitter 232 and the light receiver 233. Note that, the beam steering unit may be different from the reference axis adjustment controller 231. The beam steering unit (which may include mirror(s), lens/lenses, or prism(s)) is configured to direct the pulse light or the reflected pulse light, which travel between the light transmitter 232 and the light receiver 233; on the other hand, the reference axis adjustment controller 231 is configured to tilt the LiDAR apparatus 230 (e.g., beam steering unit(s), the light transmitter 232, and the light receiver 233 as a whole). For example, details or modifications of a beam steering unit, a light transmitter, or a light receiver are disclosed in U.S. application Ser. Nos. 18/084,562 and 17/900,864, the disclosure of which is hereby incorporated by reference herein in its entirety and made a part of this specification. A reference axis adjustment controller of the present invention may alter the reference axis or the tilt angle of the LiDAR apparatus 10 of U.S. application Ser. No. 18/084,562, which includes the light transmitter 200, the beam steering unit 260, and the light receiver 280.

In an embodiment, a reference axis adjustment controller of the present invention may be implemented in the form of the beam steering unit 120, 220, 320, 420 of U.S. application Ser. No. 17/900,864, which may include at least one steering component (e.g., the non-movable steering component 120a (e.g., a reflective mirror), the movable steering component 120b (e.g., a 2D MEMS resonant mirror), the movable steering component 220a/220b (e.g., a 1D MEMS resonant mirror), the steering component 320a (e.g., a mechanical mirror), the steering component 320b (e.g., a polygon mirror), or the steering component 420a/420b (e.g., a Risley prism)). In an embodiment, a reference axis adjustment controller of the present invention may also include the optical separator 140 and the optical deflector 150 of U.S. application Ser. No. 17/900,864.

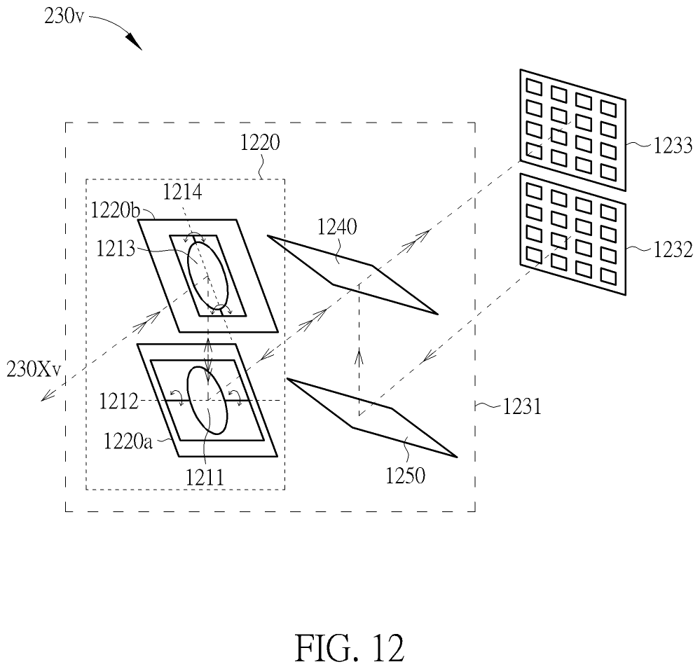

For example, FIG. 12 is a schematic diagram of a LiDAR apparatus 230v according to an embodiment of the present invention. The LiDAR apparatus 230 may be implemented in the form of the LiDAR apparatus 230v, which may include a reference axis adjustment controller 1231, a light transmitter 1232, and a light receiver 1233. The reference axis adjustment controller 1231 may include an optical redirector 1220, which is configured to adjust a reference axis 230Xv of the LiDAR apparatus 230v, an optical separator 1240, and an optical deflector 1250. The optical redirector 1220 may include 1D MEMS resonant mirrors 1220a and 1220b. The 1D MEMS mirror 220a may include a reflective mirror surface 1211 and a flexure resonating around an axis 1212 at slow frequency. The 1D MEMS mirror 1220b may include a reflective mirror surface 1213 and a flexure resonating around an axis 1214 at fast frequency. In an embodiment, the reference axis adjustment controller 1231 may increase spatial angle resolution as a beam steering unit disclosed in U.S. application Ser. No. 17/900,864.

In an embodiment, the reference axis adjustment controller 231 may include a (tilt angle) adjuster (e.g., a MEMS mirror or array of MEMS mirrors) to alter the tilt angle of the LiDAR apparatus 230 by changing offset(s) (e.g., an offset voltage or offset current) of the vertical scanning of the MEMS mirror(s). The adjuster may be designed similarly to the adjuster 190.

The reference axis adjustment controller 231 may determine/measure/obtain the pitch angle of a vehicle or the inclination angle of a road surface by leveraging LiDAR technology (e.g., point cloud data captured by the light receiver 233). The reference axis adjustment controller 231 may use previous point cloud data output from the LiDAR apparatus 230 corresponding to the previous reference axis 230X to alter the previous reference axis 230X of the LiDAR apparatus 230, such that the LiDAR apparatus 230 corresponding to the adjusted reference axis 230X may generate new point cloud data.

The reference axis adjustment controller 221 or 231 may be implemented in the form of the reference axis adjustment controller 10. The reference axis 220X corresponding to the reference axis adjustment controller 221 and the reference axis 230X corresponding to the reference axis adjustment controller 231 may be aligned/parallel or nonaligned/nonparallel. The reference axis 220X or 230X may be adjusted to become parallel to the inclination angle of an incoming slope.

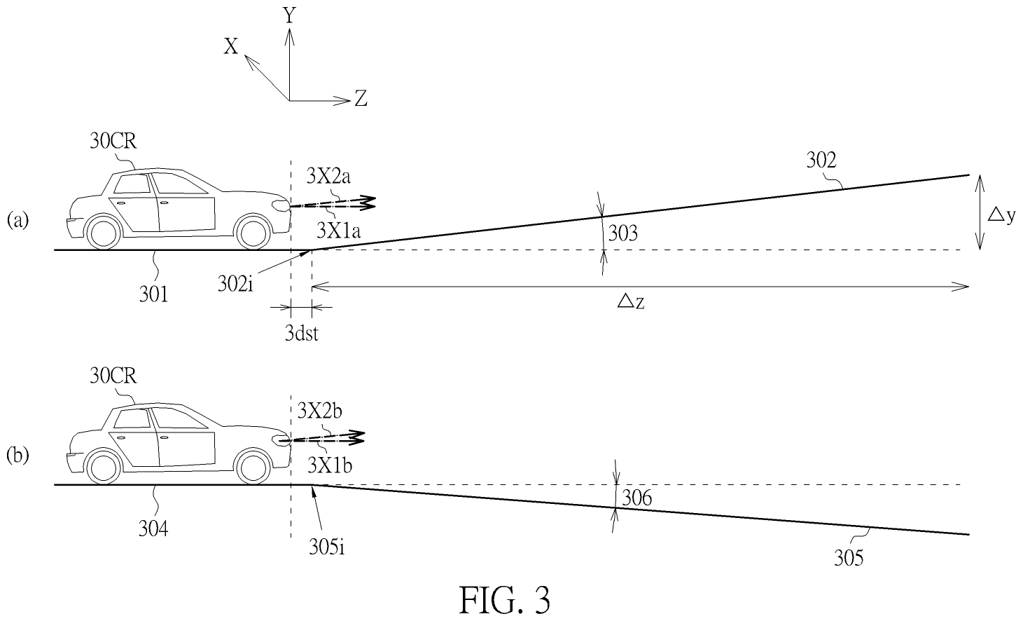

FIG. 3 is a schematic diagram of how the angle polarity of a slope (i.e., a road surface) is defined according to an embodiment of the present invention. In FIG. 3, (a) illustrates a slope 302 has a positive polarity, indicating that it is an upward slope with respect to the (relative) horizontal plane, and the inclination angle 303 is a positive angle. In FIG. 3, (b) illustrates a slope 305 of a negative polarity, indicating that it is a downward slope with respect to the (relative) horizontal plane, and the inclination angle 306 is a positive angle.

A smart device 30CR may measure the inclination angle of the incoming slope and alter a reference axis of an apparatus of the smart device 30CR before the smart device 30CR enters the incoming slope. Before a smart device 30CR in a slope 301 moves uphill and enters the slope 302 shown in (a) of FIG. 3, a reference axis 3X1a of an apparatus of the smart device 30CR (e.g., the reference axis 220X of the automotive lamp apparatus 220 or the reference axis 230X of the LiDAR apparatus 230) may be adjusted to become a reference axis 3X2a. Before the smart device 30CR in a slope 304 goes downhill and encounters the slope 306 shown in (b) of FIG. 3, a reference axis 3X1b of an apparatus of the smart device 30CR may be adjusted to become a reference axis 3X2b. The smart device 30CR may be implemented in the form of the smart device 20CR.

In an embodiment, the timing required to alter a reference axis of an apparatus of the smart device 30CR may depend on a distance (e.g., 3dst) between (the leading edge of) the smart device 30CR and an initial point (e.g., 302i) of the incoming slope (e.g., 302), the velocity of the smart device 30CR, or the acceleration of the smart device 30CR.

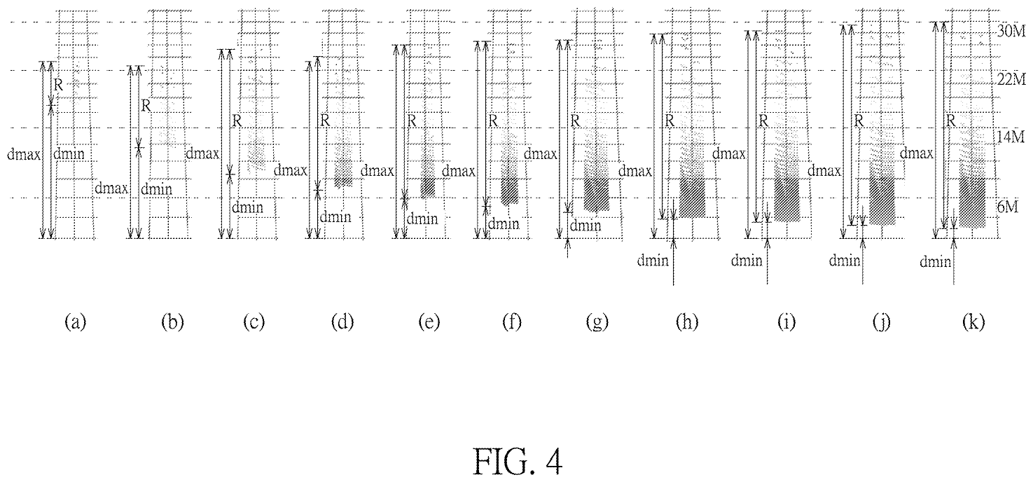

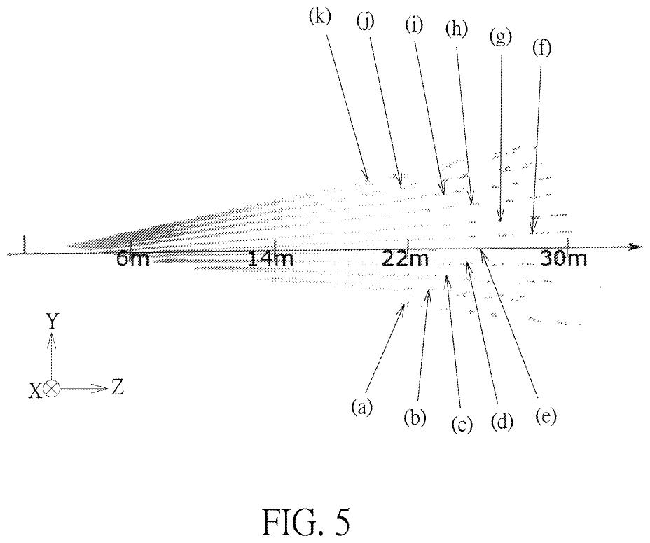

FIG. 4 is a schematic diagram of a top view of point cloud data measured using LiDAR technology (e.g., point cloud data measured by the LiDAR apparatus 230) according to an embodiment of the present invention. FIG. 5 is a schematic diagram of a side view of the point cloud data shown in FIG. 4. Point cloud data is a discrete set of data points in space for samples on a surface or of an environment. The position of one point of point cloud data has its set of Cartesian coordinates (x, y, z).

In FIG. 4 and FIG. 5, (a), (b), (c), and (d) illustrate inclination angles of slopes (e.g., the inclination angle 306 of the slope 305), which are −8, −6, −4, and −2 degrees, respectively (when the reference axis of the LiDAR apparatus 230 is parallel to the (relative) horizontal plane). In FIG. 4 and FIG. 5, (e) illustrates the inclination angle of a slope (e.g., the (relative) horizontal plane), which is 0 degrees (when the reference axis of the LiDAR apparatus 230 is parallel to the (relative) horizontal plane). In FIG. 4 and FIG. 5, (f), (g), (h), (i), (j), and (k) illustrate inclination angles of slopes (e.g., the inclination angle 303 of the slope 302), which are 2, 4, 6, 8, 10, and 12 degrees, respectively (when the reference axis of the LiDAR apparatus 230 is parallel to the (relative) horizontal plane).

It is shown that when a road surface changes from flat (e.g., (e) of FIG. 4) to downhill (e.g., (a), (b), (c), or (d) of FIG. 4), a minimum distance dmin measured in the point cloud data increases drastically and a maximum distance dmax measured in the point cloud data remains the same so that a distance range R measured in the point cloud data drops. On the other hand, when a road surface changes from flat (e.g., (e) of FIG. 4) to uphill (e.g., (f), (g), (h), (i), (j), or (k) of FIG. 4), the minimum distance dmin decreases slowly and the maximum distance dmax remains approximately the same so that the distance range R increases slightly. The minimum distance dmin may refer to a distance between the rearmost edge of a light beam in point cloud data and the leading edge of (a LiDAR apparatus of) a smart device (e.g., 20CR or 30CR). The maximum distance dmax may refer to a distance between the foremost edge of the light beam in the point cloud data and the leading edge of the smart device. The distance range R may refer to a distance between the rearmost edge and the foremost edge of the light beam in the point cloud data.

According to FIG. 5, the coordinates of every point may be found/determined according to point cloud data, such that the inclination angle of a slope passing through the origin may be measured according to tan⁻¹(Δy/Δz), where Δy is the difference between the y-coordinates of two points on the slope in point cloud data, and Δz is the difference between the z-coordinates of the two points in the point cloud data.

According to FIG. 4, the inclination angle of a slope may be calculated according to the minimum distance dmin, the maximum distance dmax, or the distance range R; in other words, the inclination angle of a slope may be a function of the minimum distance dmin, the maximum distance dmax, or the distance range R.

In a word, the pitch angle of a vehicle or the inclination angle of a road surface can be calculated by leveraging LiDAR technology (e.g., using point cloud data output from the LiDAR apparatus 230). A LiDAR apparatus (e.g., 230) may serve as a remote sensor; a reference axis adjustment controller (e.g., 10, 221, 231, or 90) may serve as a virtual inclination angle sensor to acquire the inclination angle of an incoming slope by analyzing point cloud data from the LiDAR apparatus.

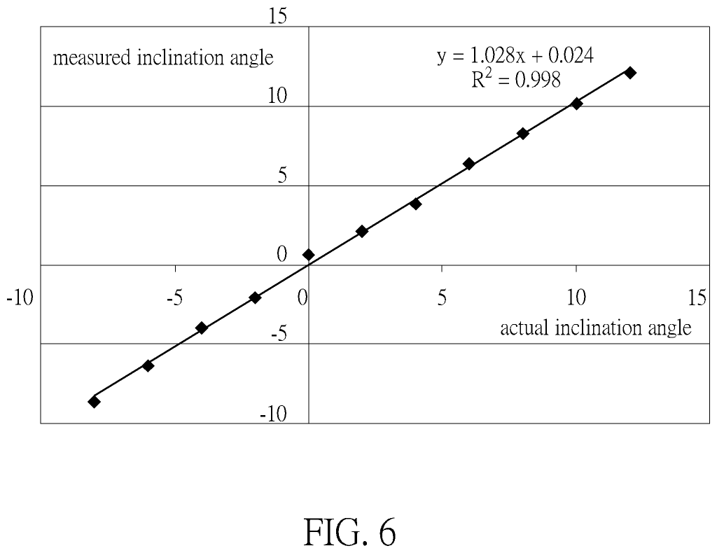

FIG. 6 is a schematic diagram of the relationship between an actual inclination angle and its corresponding inclination angle measured according to point cloud data from a LiDAR apparatus (e.g., 230) according to an embodiment of the present invention. In FIG. 6, the horizontal (x) axis represents the (actual) inclination angle; the vertical (y) axis represents the (measured) inclination angle measured from the point cloud data. The fit to data in x and y may satisfy y=1.028x+0.024. The R-squared value may be 0.998.

According to FIG. 6, the inclination angle measured from the point cloud data accurately quantifies the actual inclination angle. Therefore, a reference axis adjustment controller (e.g., 10, 221, 231, or 90) may utilize LiDAR technology to determine/measure/obtain the inclination angle of an incoming slope so that a reference axis (e.g., 220X, 230X, 3X1a, or 3X1b) or a tilt angle of an apparatus (e.g., the automotive lamp apparatus 220 or the LiDAR apparatus 230) may be adjusted accordingly.

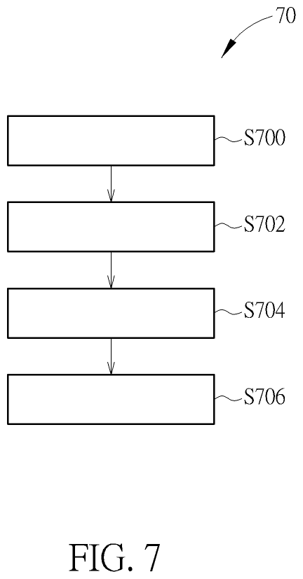

FIG. 7 is a schematic diagram of a reference axis adjustment method 70 according to an embodiment of the present invention. The reference axis adjustment method 70 may be compiled into a program code (e.g., 114), which may be executed on and stored in a reference axis adjustment controller (e.g., 10, 221, 231, or 90). The steps of the reference axis adjustment method 70 may include the following steps:

Step S700: Start.

Step S702: Obtain the inclination angle of a slope with respect to a (relative) horizontal plane.

Step S704: Instruct to adjust a reference axis of an apparatus according to the inclination angle of the slope before the apparatus enters the slope.

Step S710: End.

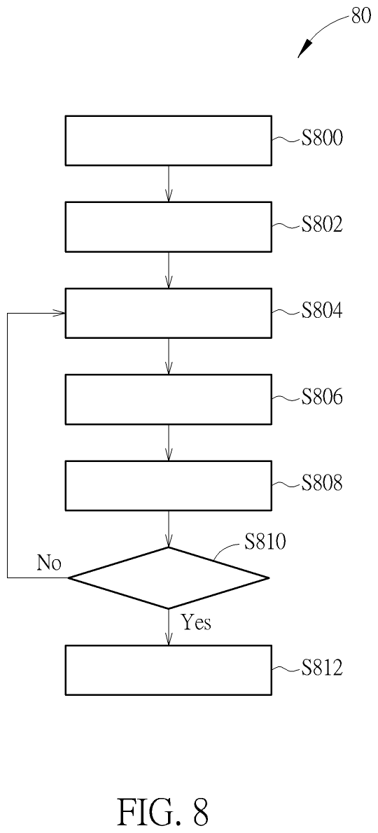

FIG. 8 is a schematic diagram of a reference axis adjustment method 80 according to an embodiment of the present invention. The reference axis adjustment method 80 may be compiled into a program code (e.g., 114), which may be executed on and stored in a smart device (e.g., 20CR or 30CR). The steps of the reference axis adjustment method 80 may include the following steps:

Step S800: Start.

Step S802: Initiate a LiDAR apparatus (e.g., 230).

Step S804: Identify an (upcoming) slope (e.g., 302) (i.e., a road surface or a part of a road surface).

Step S806: Find/determine the location of the slope and/or the inclination angle of the slope according to point cloud data output from the LiDAR apparatus.

Step S808: Adjust a reference axis (e.g., 220X, 230X, 3X1a, or 3X1b) or a tilt angle of an apparatus (e.g., the automotive lamp apparatus 220 or the LiDAR apparatus 230).

Step S810: Determine whether the apparatus is aimed properly. If yes, go to Step S812; otherwise, go to Step S804.

Step S812: End.

In an embodiment, in Step S804, a reference axis adjustment controller (e.g., 10, 221, 231, or 90) may identify a slope by comparing a distance range R (or a minimum distance dmin) measured in point cloud data with the distance range R (or the minimum distance dmin) depicted in (e) of FIG. 4.

In Step S806, the reference axis adjustment controller may analyze point cloud data from the LiDAR apparatus to obtain the inclination angle of the slope and/or determine the location of the slope.

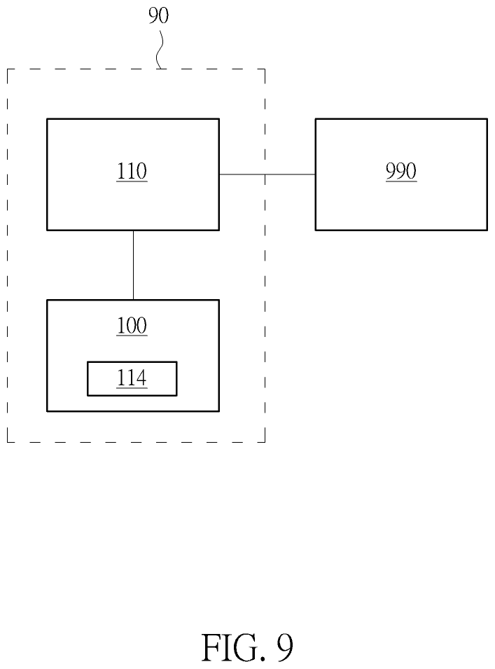

In FIG. 1 or 2, the reference axis adjustment controller 10, 221, or 231 includes an adjuster (e.g., 190); however, the present invention is not limited thereto. For example, FIG. 9 is a schematic diagram of a reference axis adjustment controller 90 and an adjuster 990 according to an embodiment of the present invention.

In an embodiment, the reference axis adjustment controller 90 and the adjuster 990 are disposed in one smart device (e.g., 20CR or 30CR). The reference axis adjustment controller 90 and the adjuster 990 are directly connected or electrically coupled.

In another embodiment, the adjuster 990 is disposed in a smart device (e.g., 20CR or 30CR), and communicatively coupled to the reference axis adjustment controller 90 outside the smart device via a wireless/wired connection. Accordingly, the reference axis adjustment controller 221 of the smart device 20CR may be replaced by a first adjuster, and the reference axis adjustment controller 231 may be replaced by a second adjuster. The first adjuster and the second adjuster may be the same adjuster, integrated into one adjuster, or different adjusters.

The wireless connection between the adjuster 990 inside a smart device and the reference axis adjustment controller 90 outside the smart device may be short range connection such as IEEE 802.15.4 (ZigBee) or Bluetooth/BLE, medium range connection such as Wi-Fi, or long range connection such as LTE or 5G. The reference axis adjustment controller 90 may be disposed in electronic device(s) such as a server, a smart phone, or other devices which meet most fast computing needs and have massive battery capacities. Leveraging the computing resource of the electronic device(s) may reduce the complexity, power consumption, or extend battery life of the smart device by offloading all (computation) processing to the electronic device(s). Besides, the reference axis adjustment controller 90 may make full use of point cloud data from a LiDAR apparatus, LiDAR apparatuses in one vehicle, or LiDAR apparatuses in different vehicles. Point cloud data from different vehicles may help the reference axis adjustment controller 90 determine the inclination angle(s) of road surface(s) in advance and more precisely/accurately.

In an embodiment, the reference axis adjustment controller (e.g., 10 or 90) may applies/uses knowledge from an artificial intelligence (AI) algorithm to infer a prediction (i.e., the inclination angle of a road surface). The AI algorithm may involve supervised learning, unsupervised learning, or reinforcement learning. The AI algorithm may include neural network layers such as Convolutional Neural Network, Recurrent Neural Network, or Long Short-Term Memory network.

In an embodiment, the adjuster 190 or 990 may include at least one mirror (e.g., a (one-axis or two-axis) MEMS micro-mirror, or a MEMS based resonant mirror, which may be driven by electrostatic mechanism, electromagnetic mechanism, thermal mechanism, or piezoelectric mechanism, a mechanical driven mirror), a prism (e.g., a mechanical driven prism), a lens, or a motor. The mechanical driven mirror may be a polygon mirror to adjust the tilt angle of an apparatus. The mechanical driven prism may be a Risley prism. A (tilt angle) adjuster may be opto-mechanical.

To sum up, the invention discloses the use of LiDAR technology, which outputs point cloud data, as a remote sensor to acquire the inclination angle of an incoming slope. Besides, the invention utilize LiDAR technology to measure the inclination angle of an incoming slope so that the tilt angle of a LiDAR apparatus or automotive lamp apparatus can be adjusted accordingly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A reference axis adjustment method, for a reference axis adjustment controller, comprising:
obtaining an inclination angle of a slope with respect to a horizontal plane; and
instructing to adjust a reference axis of an apparatus according to the inclination angle of the slope before the apparatus enters the slope.

2. The reference axis adjustment method of claim 1, further comprising:
obtaining point cloud data from a Light Detection and Ranging (LiDAR) light receiver or using LiDAR technology.

3. The reference axis adjustment method of claim 1, wherein the step of obtaining the inclination angle of the slope with respect to the horizontal plane comprises:
analyzing point cloud data to obtain the inclination angle of the slope.

4. The reference axis adjustment method of claim 1, further comprising:
analyzing point cloud data to identify the slope.

5. The reference axis adjustment method of claim 1, further comprising:
analyzing point cloud data to determine a location of the slope.

6. The reference axis adjustment method of claim 1, wherein the reference axis of the apparatus is adjusted to be parallel to the inclination angle of the slope.

7. The reference axis adjustment method of claim 1, wherein the apparatus is a LiDAR apparatus or an automotive lamp apparatus, and the automotive lamp apparatus is a headlamp or a tail light.

8. The reference axis adjustment method of claim 1, wherein the reference axis adjustment controller is disposed in the apparatus inside a vehicle or communicatively coupled to the vehicle.

9. The reference axis adjustment method of claim 1, wherein the reference axis adjustment controller comprises a motor configured to adjust the reference axis of the apparatus according to a tilt angle control signal.

10. The reference axis adjustment method of claim 1, wherein the reference axis adjustment controller comprises at least one mirror arranged in an array to adjust the reference axis of the apparatus by changing an offset voltage of vertical scanning of the at least one mirror.

11. A reference axis adjustment controller, comprising:
a storage circuit, configured to store instructions of:
obtaining an inclination angle of a slope with respect to a horizontal plane; and
instructing to adjust a reference axis of an apparatus according to the inclination angle of the slope before the apparatus enters the slope; and
a processing circuit, coupled to the storage device, configured to execute the instructions stored in the storage circuit.

12. The reference axis adjustment controller of claim 11, wherein the instructions further comprises:
obtaining point cloud data from a Light Detection and Ranging (LiDAR) light receiver or using LiDAR technology.

13. The reference axis adjustment controller of claim 11, wherein the step of obtaining the inclination angle of the slope with respect to the horizontal plane comprises:
analyzing point cloud data to obtain the inclination angle of the slope.

14. The reference axis adjustment controller of claim 11, wherein the instructions further comprises:
analyzing point cloud data to identify the slope.

15. The reference axis adjustment controller of claim 11, wherein the instructions further comprises:
analyzing point cloud data to determine a location of the slope.

16. The reference axis adjustment controller of claim 11, wherein the reference axis of the apparatus is adjusted to be parallel to the inclination angle of the slope.

17. The reference axis adjustment controller of claim 11, wherein the apparatus is a LiDAR apparatus or an automotive lamp apparatus, and the automotive lamp apparatus is a headlamp or a tail light.

18. The reference axis adjustment controller of claim 11, wherein the reference axis adjustment controller is disposed in the apparatus inside a vehicle or communicatively coupled to the vehicle.

19. The reference axis adjustment controller of claim 11, wherein the reference axis adjustment controller comprises a motor configured to adjust the reference axis of the apparatus according to a tilt angle control signal.

20. The reference axis adjustment controller of claim 11, wherein the reference axis adjustment controller comprises at least one mirror arranged in an array to adjust the reference axis of the apparatus by changing an offset voltage of vertical scanning of the at least one mirror.
